(19) United States
(12) Patent Application Publication
(10) Pub. No.: US 2006/0254611 A1
(43) Pub. Date: Nov. 16, 2006

(54) Acid-free cleaning process for substrates, in particular masks and mask blanks

(76) Inventors: Harald Koster, Oestrich-Winkel (DE); Karsten Branz, Dettingen (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 11/401,461

(22) Filed: Apr. 11, 2006

Related U.S. Application Data
(60) Provisional application No. 60/670,287, filed on Apr. 12, 2005.

(51) Int. Cl. B08B 3/12; B08B 3/00; B08B 6/00

(52) U.S. Cl. 134/1; 134/1.1; 134/26

(57) ABSTRACT

The present invention relates to a novel and advantageous process for cleaning substrates, in particular masks and mask blanks. The process according to the invention is characterized by consecutive process steps comprising UV-treatment, fulljet cleaning, megasonic cleaning and DI (deionized) water cleaning. The process does not include an acid cleaning step.

This application claims the benefit of the filing date of U.S. Provisional Application Ser. No. 60/670,287 filed Apr. 12, 2005, which is incorporated by reference herein.

### BACK SIDEGROUND OF THE INVENTION

1. Field of the Invention

The present invention relates to a novel and advantageous process for cleaning substrates, in particular masks and mask blanks avoiding the use of any acid during the cleaning process.

2. Description of the Prior Art

Mask blanks are the basis for photomasks, which serve as a master when a circuit pattern is transferred to a wafer. If the pattern formed on the surface of the photomask has defects or foreign pattern thereon in an amount exceeding the critical resolution, they can be transferred to the wafer as a part of the pattern. Therefore, cleaning of substrates, in particular masks and mask blanks is a big issue and the respective processes should lead to highly precise results.

In mask houses two different cleaning processes are used, the after strip and final clean process. Both have the goal to remove particles, for example from a structured chromium side in the case of chrome on glass substrates. Known cleaning processes include a wide range of chemicals to achieve the required specification according to ITRS (abbreviation for International Technology Roadmap for Semiconductors) roadmap. In many cases the utilized chemicals lead to further problems. In particular, sulfate residues of sulfuric acid used during the cleaning process is a well known source for haze.

At a very early stage of mask blank manufacturing different kind of problems occur. Therefore a cleaning process needs to be efficient and should lead to useful results. For example in the case of chrome on glass substrates, effectiveness of the cleaning process must be given for both, the glass and the chromium side, respectively. For this reason a suitable cleaning process must be flexible, while simultaneously possible contamination sources (like sulfate) should be avoided.

The cleaning process during the manufacturing of mask blanks is one of the crucial steps determining the final quality of the blank. Also considering the contamination history of the substrate the particle surface interaction is different during mask blank manufacturing as compared to a final clean process after strip and pre clean during a mask making process. That is, a cleaning process applied during the manufacturing of mask blanks must fulfill highest requirements.

U.S. Pat. No. 6,242,165 discusses a process for removing organic material in the fabrication of structures, such as wafer surfaces during the production of semiconductor devices, by making use of a composition with one compound being in the supercritical state. The compound is selected from an oxidizer, preferably sulfur trioxide, or a compound like carbon monoxide, ammonia, water an inert gas etc.

U.S. Pat. No. 6,423,147 discloses the use of a cleaning solution for removing small particles from semiconductor wafers comprising hydrogen peroxide, ammonia and deionized water in a particular ratio.

WO 04/074931 refers to a method for semiconductor cleaning making use of megasonic cleaning process.

U.S. Pat. No. 6,277,205 refers to a multi-step process for cleaning photomasks and U.S. Pat. No. 6,841,311 to a multi-step process for cleaning PSM (phase shift masks), however, according to both prior art documents sulfuric acid is used during the process. However, as mentioned before, sulfate residues lead to undesired contaminations and finally to haze, which is to be avoided.

Hence, there exists a strong need for an efficient process for cleaning mask blanks avoiding the use of acid, in particular of sulfuric acid.

### SUMMARY OF THE INVENTION

In accordance with the invention, there is provided an efficient front and back side cleaning process for mask blanks. The process comprises different cleaning modules, namely an UV treatment, fulljet cleaning, megasonic cleaning and DI water rinse. The efficiency of different cleaning modules (cleaning steps) can be optimized for the different substrates and mask surfaces, such as glass substrates, chromium on glass substrates and phase shifter material, such as tantal-silica coated PSMs.

The process according to the invention features new capabilities for smallest soft defect removal and careful PSM cleaning, and hence serves the needs of the photomask and semiconductor industry for the 90 and 65 nm generation, and beyond.

A useful device for applying the process according to the invention is the Advanced Single Substrate Aqueous Cleaning System, ASC5500, provided by STEAG HamaTech. It has been designed especially for the critical challenges of defect-free cleaning of masks exposed at 193 nm, 157 nm, and EUV (Extreme UV, i.e. less than 100 nm, currently app. 19 nm). The tool is equipped with the process relevant stations, namely an UV-Lamp, a fulljet arm and a megasonic arm.

During the cleaning process in accordance with the present invention, an Excimer-lamp (λ=172 nm) is used for generating ozone and atomic oxygen to prepare the surface, namely to degrade possible organic contamination and increase the wettability for the used chemicals. Wetting the surface of the mask blank is necessary, otherwise particles will remain.

The process according to the invention is acid-free and hence avoids hazing and is characterized by only utilizing DI-Water, ammonium hydroxide and hydrogen peroxide as cleaning media during fulljet and/or megasonic action.

The cleaning process according to the invention can be adapted to various substrates by varying numerous parameters, such as

Nitrogen, Oxygen or Argon Flow of the UV Lamp

As to the nitrogen flow, 0 to 10 liter/min. are useful, and 0 to 8 liter/min are preferred. As to the oxygen flow, 0 to 10 liter/min are useful, and 0 to 2 liter/min are preferred. With respect to argon, flow rates of from 0 to 10 liter/min are useful with 0 to 5 liter/min being preferred.

Flow of Media

As to the flow of DI-water, rates of from 0 to 6 liter/min. are useful with 0 to 4 liter/min being preferred and 1 to 4 liter/min being more preferred. The flow of ammonium hydroxide and hydrogen peroxide can be adjusted to 0 to 5 liter/min. with 0 to 3 liter/min being preferred.

Chemical Concentration

A suitable chemical concentration of ammonium hydroxide is from 0 to 3% and for hydrogen peroxide of from 0 to 2%.

Speed of the Swivelarm

As to the speed of the swivelarm, suitable rages are for example from 0 to 360 degree/sec. with 0 to 20 degree/sec. being preferred, more preferred are 0 to 10 degree/sec. and most preferred 1 to 6 degree/sec. (for megasonic and fulljet).

Motion (Horizontal) of Blank

Suitable ranges are for example 0 to 3000 rpm with 0 to 1000 rpm being preferred. During dry or wet process, 10 to 500 rpm are suited and 10 to 1500 rpm during spin drying process.

Motion (Vertical) of Blank

Suitable ranges are for example 0 to 250 mm/sec., preferably 0 to 100 mm/sec. and more preferred 5 to 50 mm/sec.

Fulljet Pressure

The pressure can vary from 0 to 12×10⁵ N/m², suitable media are ammonium hydroxide and/or hydrogen peroxide and/or DI water.

Megasonic Capacity and Frequency

As to these values, 30 to 100% power are suitable, with 25 to 100% being preferred and 50 to 80% being most preferred at 1 to 5 MHz or 1 to 3 MHz with preferred media ammonium hydroxide and/or hydrogen peroxide and/or DI water.

Temperature of DI Water

Suitable temperatures are in the range from 20° C. to 95° C., preferably from 20° C. to 90° C.

The optimum parameter set for the megasonic cleaning process can be adapted for mask cleaning and blank cleaning processes, i.e. for different substrates. When adjusting the parameter, circumstances as small structures on masks, which can be damaged by a too high megasonic output intensity, can be considered.

The process according to the invention is further described in the examples which are presented to illustrate the invention without restricting the scope:

### EXAMPLE 1

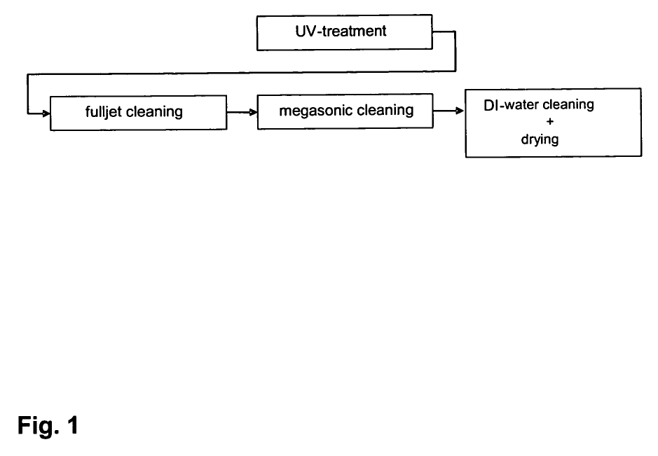

FIG. 1 shows a schematic drawing of the modules applied during the process according to the invention. As apparent from the figure, an UV treatment is followed by a fulljet cleaning step, followed by a megasonic cleaning and a final DI water rinse. After the cleaning, the substrate is dried.

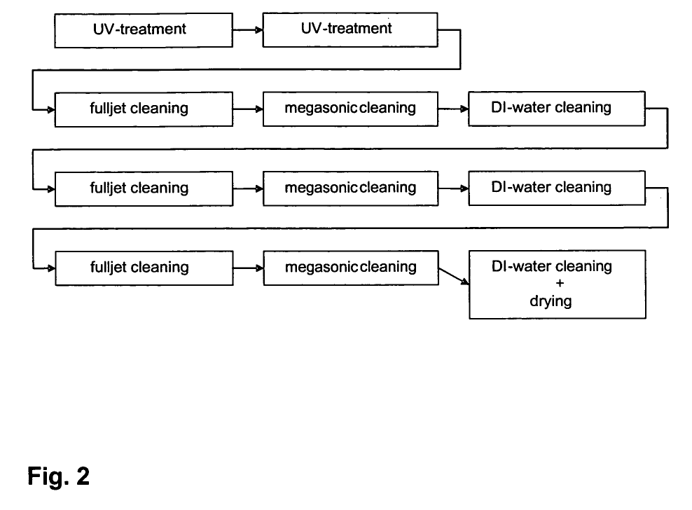

FIG. 2 shows a schematic drawing for front- and back side cleaning of a mask or mask blank showing a preferred embodiment of the process according to the present invention.

The UV-treatment is carried out at the front-side, then at the back side, then the front-side is cleaned, then the back side is cleaned and again the front side is cleaned. Such a process is preferred for chrome on glass substrates. For glass substrates, UV-treatment is carried out at the back side, then at the front side, and then the back side and afterwards the front-side are cleaned. Such a practice is for example suited with phase shifter materials und EUV multilayer blanks. The skilled person will choose a suitable sequence for respective substrates.

### EXAMPLE 2

In order to show the capability for 90 and 65 nm node, high end mask blanks with zero defects >0.3 μm were used (available by SCHOTT Lithotec) in order to develop a cleaning process for masks and mask blanks with a high cleaning efficiency for particles <0.3 μm.

For cleaning blanks, in principle two different kinds of surfaces should be addressed, namely a chrome side and a glass side. For cleaning the chrome surface a different set of parameters is required, as the interaction of particles with the chrome surface is different to the interaction to a glass surface. The chrome layer is more difficult to clean than a glass surface. By keeping the process flow unchanged the process periods of each step are adapted for each substrate type.

However, the modular process according to the invention allows the perfect adaption of the respective parameter to the respective surface. Since the modules can be repeated with different parameter for back side and front side of the mask or mask blank, the process allows tailor-made cleaning of different substrates.

For example, Phase Shift Mask Blanks with a Ta/SiO2 surface allow using a soft cleaning process similar to one useful for glass substrate cleaning. Results from the new cleaning process show a dramatically reduced phase shift and transmission change per cleaning cycle compared to the actual standard cleaning process.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

In the foregoing and in the examples, all temperatures are set forth uncorrected in degrees Celsius and, all parts and percentages are by weight, unless otherwise indicated.

The entire disclosure of all applications, patents and publications, cited herein U.S. Provisional Application Ser. No. 60/670,287, filed Apr. 12, 2005, is incorporated by reference herein.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

What is claimed is:

1. Process for cleaning substrates comprising the following process steps
a) UV-treatment
b) fulljet cleaning
c) megasonic cleaning
d) DI water rinse
and optionally drying the substrate.

2. Process according to claim 1, wherein the substrates are masks or mask blanks.

3. Process according to claim 1, wherein two UV treatment steps for face and back side of the substrate are applied, and the subsequent steps b) to d) are repeated at least one time prior to drying.

4. Process according to claim 3, wherein the steps b) to d) are repeated three times altogether.

5. Process according to claim 3, wherein the steps b) to d) are applied to the face, the back side and again to the face of the substrate.

6. Process according to claim 1 wherein in steps b) to c) ammonium hydroxide and hydrogen peroxide are used in combination with megasonic and/or fulljet cleaning.

7. Process according to claim 1 making no use of any acid.
